(19) United States
(12) Patent Application Publication
(10) Pub. No.: US 2012/0011079 A1
(43) Pub. Date: Jan. 12, 2012

(54) DERIVING ENTITY-CENTRIC SOLUTION MODELS FROM INDUSTRY REFERENCE PROCESS AND DATA MODELS

(75) Inventors: Santhosh Kumaran, Peekskill, NY (US); Rong Liu, Sterling, VA (US); Yashodhara M. Patnaik, Yorktown Heights, NY (US); Frederick Y. Wu, Greenwich, CT (US)

(73) Assignee: INTERNATIONAL BUSINESS MACHINES CORPORATION, Armonk, NY (US)

(21) Appl. No.: 12/834,389

(22) Filed: Jul. 12, 2010

(51) Int. Cl. G06Q 10/00

(52) U.S. Cl. 705/348

(57) ABSTRACT

A mechanism is provided for forming a business entity model. A selection of business components is received from a business function model to be selected business components. Activities are found in an industry reference model to be selected activities corresponding to selected business components. Based on the selected activities, industry reference model is scoped to be a scoped industry reference model, which includes reducing business process models in the industry reference model to selected business process models corresponding to selected activities, reducing data models in the industry reference model to selected data models corresponding to use cases of selected activities, and reducing service operations in the industry reference model to selected service operations corresponding to the selected activities. Selected activities and scoped industry reference model are customized. Based on a business entity template, selected activities, and scoped industry reference model, business entities are generated to form a business entity model.

### BACKGROUND

Exemplary embodiments relate to industry reference models, and more specifically, to deriving business specific solutions form industry reference models.

Industries often publish rich reference data and process models, e.g., Insurance Application Architecture (IAA), Information Framework (IFW), etc, in order to accelerate solution development. However, creating solutions from these reference models often requires intensive customization. The customization is often done manually and thus is very time consuming. As a result, usually, these reference models are used only as reference documents, and their rich content has not been fully used to drive downstream solution artifacts. Moreover, since customization is done in an ad-hoc way, it may seem difficult to manage and consolidate the customized solutions created for different projects to constitute consistent enterprise level models.

### BRIEF SUMMARY

According to exemplary embodiments, a computer implemented method forming a business entity model from an industry reference model is provided. A business function decomposition model is received and the business decomposition function model includes business components. An industry reference model is received. A selection of business components is received in the business decomposition function model to be selected business components. Activities are found in the industry reference model to be selected activities that correspond to the selected business components. Based on the selected activities, the industry reference model is scoped to be a scoped industry reference model. Scoping the industry reference model includes reducing the business process models in the industry reference model to selected business process models that correspond to selected activities, reducing the data models in the industry reference model to selected data models that correspond to use cases of the selected activities, and reducing the service operations in the industry reference model to selected service operations that correspond to the selected activities. The scoped industry reference model is customized. Based on a business entity template and the scoped industry reference model, business entities are generated to form a business entity model as a software program.

Additional features are realized through the techniques of the present disclosure. Other systems, methods, apparatus, and/or computer program products according to other embodiments are described in detail herein and are considered a part of the claimed invention. For a better understanding of exemplary embodiments and features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features of the present disclosure are apparent from the following detailed description taken in conjunction with the accompanying drawings in which:

FIG. 1 illustrates a block diagram of software elements for deriving business solutions in accordance with exemplary embodiments.

FIG. 2 illustrates a flow chart in accordance with exemplary embodiments.

FIG. 3 illustrates a flow chart in accordance with exemplary embodiments.

FIG. 4 illustrates a flow chart in accordance with exemplary embodiments.

FIG. 5 illustrates a flow chart in accordance with exemplary embodiments.

FIG. 6 illustrates an example of a computer having capabilities, which may be included in exemplary embodiments.

### DETAILED DESCRIPTION

Exemplary embodiments provide repeatable and (semi-) automated methods for deriving solutions from industry reference models via a software tool 20 (discussed below). Industry reference models may be referred to as enterprise models. In other words, exemplary embodiments provide a systematic, semi-automatic and/or automatic approach for deriving business entity-centric solutions from industry reference models. The software tool 20 is configured to execute (facilitate) each operation to automatically create a business entity solution and/or assist a user to create a business entity solution. For example, via the software tool 20, an organization can apply the business function decomposition model to identify opportunities for improvement and initiate information technology (IT) development. The models in an industry reference model may be linked to the components of the business function decomposition model (e.g., models of processes needed to support the activities in a component). Then, the organization can reference to the relevant models in the industry reference model, rather than starting from scratch, to accelerate the development of the business entity solution.

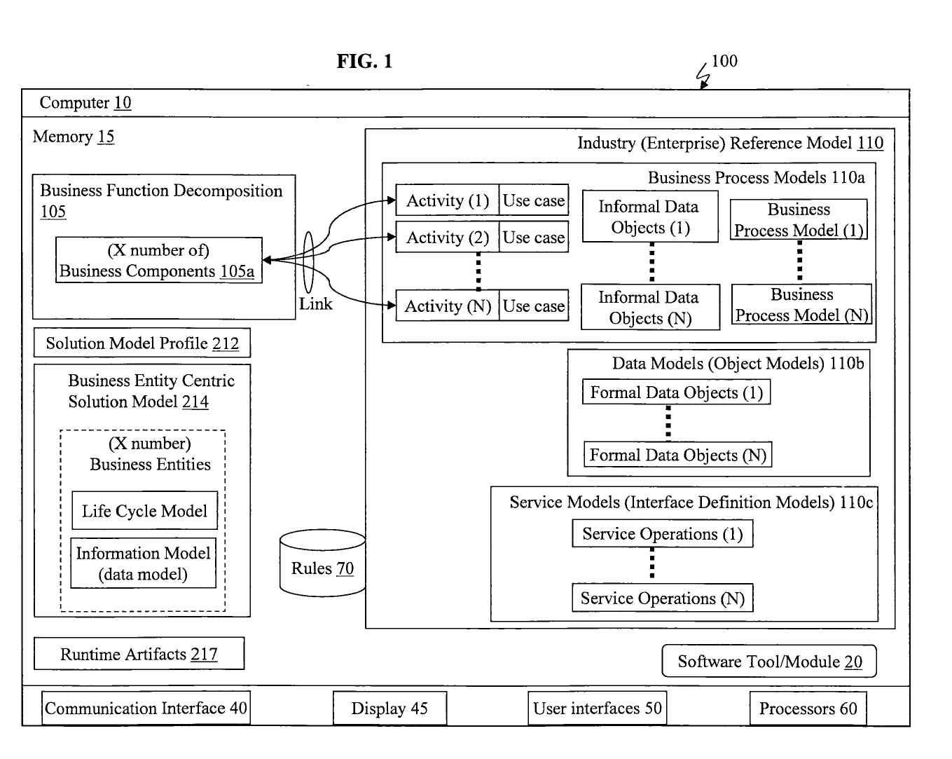

Now turning to FIG. 1, FIG. 1 illustrates a block diagram 100 of a computer having various software elements for deriving business entity-centric solutions in accordance with exemplary embodiments.

The diagram 100 depicts a computer 10 which may be one or more servers 10 or any type of computing device. The server 10 may include and/or be coupled to memory 15, a communication interface 40, display 45, user interfaces 50, processors 60, and software 20. The communication interface 40 comprises hardware and software for communicating over a network. The user interfaces 50 may include, e.g., a track ball, mouse, pointing device, keyboard, touch screen, etc, for interacting with the server 10, such as inputting information, making selections, etc.

The server 10 includes memory 15 which may be a computer readable storage medium. One or more applications such as the software tool 20 (module) may reside on or be coupled to the memory 15, and the software tool 20 comprises logic and software components to operate and function in accordance with exemplary embodiments in the form of computer executable instructions. The software tool 20 may include a graphical user interface (GUI) which the user can view and interact with. Although the software tool 20 is shown as a single element in FIG. 1 for conciseness, the software tool 20 may represent numerous software components (or modules) according to exemplary embodiments.

The computer 10 may load and/or include a business function decomposition model 105 and an industry reference model 110. The business function decomposition model 105 is a map of every function of a business, such as order management, human resources, accounting, manufacturing, etc. Each function (which may be a business process) is referred to as a business component 105a. The business function decomposition model 105 may be referred to as a function model (also called an activity model), which is a graphical representation of an enterprise's function within a defined scope. The purposes of the function model 105 are to describe the functions and processes, assist with discovery of information needs, help identify opportunities, and establish a basis for determining product and service costs. Functional decomposition refers broadly to the process of resolving a functional relationship into its constituent parts in such a way that the original function can be reconstructed from those parts by function composition. In general, this process of decomposition is undertaken either for the purpose of gaining insight into the identity of the constituent components, or for the purpose of obtaining a compressed representation of the global function, a task which is feasible only when the constituent processes possess a certain level of modularity. Moreover, the business function decomposition model 105 is a method used by an organization to regroup business activities into a manageable number of discreet, modular, and reusable components. Through this decomposition 105, the organization can identify opportunities for improvement and innovation, and then focus on the core capabilities needed to run the business and drive business strategy.

The industry reference model 110 is a detailed roadmap and a guideline to manage complex business processes. The industry reference model 110 typically includes a process model which includes representations of key business processes (the process model may be referred to as business process model 110a), a data model (also referred to as an object model) which includes an industry/enterprise data vocabulary (the data model may be referred to as data model 110b), and a service model which is a service design (operation) to implement automated tasks (the service model may be referred to as service model 110c). An example of an industry model is the IBM® Information FrameWork (IFW) model for the Financial Service Industry which can provide a single, consistent and technology-independent view of banking/financial services. The IFW model may include a set of templates, populated with banking-specific information. The IFW for the Financial Service Industry may include a business process model such as Unified Modeling Language (UML) activity diagrams or Websphere® Business Modeler (WBM) models, may include a data model such as a UML data model, and may include a service model such as a service interface design in UML. Moreover, the industry reference model 110 is a comprehensive framework of related business models in an industry, which may include the business process model 110a, the data model 110b, and the service design model 110c. Typically, these models 110a-c are built based on project experience and stand for the best practice in this industry. The industry reference model 110 can help organizations modernize by defining where they are, describing their desired target, and developing a road map for getting there.

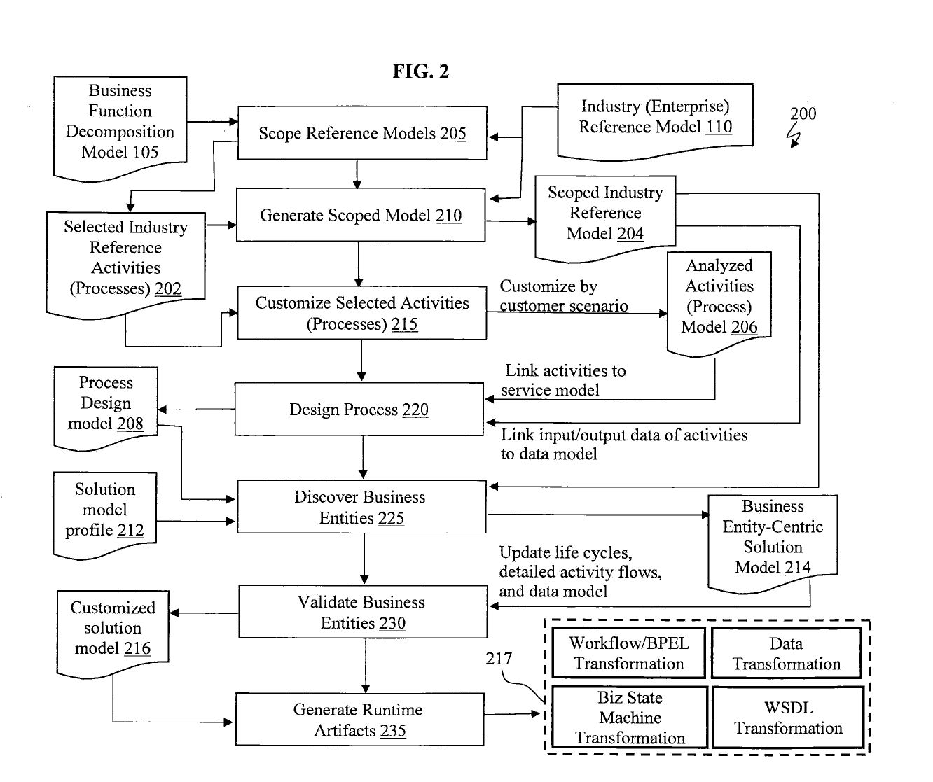

Now, turning to FIG. 2, FIG. 2 illustrates a flow chart 200 in accordance with exemplary embodiments. The software tool 20 is configured to implement the flow chart.

At operation 205, the software tool 20 receives (accesses) the business function decomposition model 105 and the industry (enterprise) reference model 110, and the software tool 20 is configured to scope the industry reference model 110 and to identify activities to be part of selected industry reference activities 202. On the display 45, the software tool 20 displays to a user the business function decomposition model 105 and the industry reference model 110. Via the user interface 50, the user may select and/or input into the GUI of the software tool 20 one or more business (function) components 105a from the business function decomposition model 105.

The software tool 20 receives the input of the selected business components 105a from the business function decomposition model 105. The software tool 20 is configured to correlate the selected business components 105a to activities in the business process models 110a, and these corresponding (selected) activities are stored/output into selected industry reference activities 202. The software tool 20 is configured to access and then scope the industry reference model 110 (also referred to as enterprise reference model) based on the selected activities. That is, the software tool 20 is able to reduce the size of the industry reference model 110 based on eliminating elements in business process models 110a, data models 110b, and service models 110c which do not correspond to the selected activities. The business components 105a are linked (mapped) to activities (such as activity 1 through activity N), and accordingly the selected business components 105a (selected by the user) are linked to corresponding activities of the business process models 110a. As such, selected business components 105a from the business function decomposition model 105 are utilized by the software tool 20 to scope the industry reference model 110.

The software tool 20 is configured to automatically select (target) reference business process models 110 (via the selected activities) based on the (identified) selected business (functions) components 105a in the business function decomposition model 105, because each activity in the business process models 110a is associated with a particular business process model in the business process models 110a. For example, each selected activity is associated with one or more different business process models 110a.

At operation 210, based on the selected activities in the selected industry reference activities 202 (indirectly, based on the selected business function components 105a) and based on the industry reference model 110, the software tool 20 is configured to generate a scoped industry reference model 204. Normally, operationalizing an industry reference model is difficult because of its size and complexity. However, in accordance with exemplary embodiments, the software tool 20 is configured to scope (to reduce in size) the industry reference model 110 based on the selected business components 105a from the business function decomposition model 105 which correlate to activities in the selected industry reference activities 202. The resulting scoped industry reference model 204 has only the elements participating in the selected business (processes) components 105a, and the software tool 20 represents (displays) the elements in a form for easy understanding and easy customization by the user. For example, the scoped industry reference model 204 (such as a scoped Information Framework (IFW) model) is created by the software tool 20 as follows: select business process models mapped to the activities in the selected business components 105; select participating informal (business) data objects for the selected business processes models; create/select a matching use case (from the business process models 110a) for each business activity in the selected business process models; find matching service operations (in the service models 110c) in the industry reference model 110 for the business activity; and generate a mapping between the informal input/output data objects of the business process models 110a and formal business input/output data objects for the activity (in the data model 110b). In the financial example, the software tool 20 utilizes the scoped IFW models as a starting point for (further) analysis and customization.

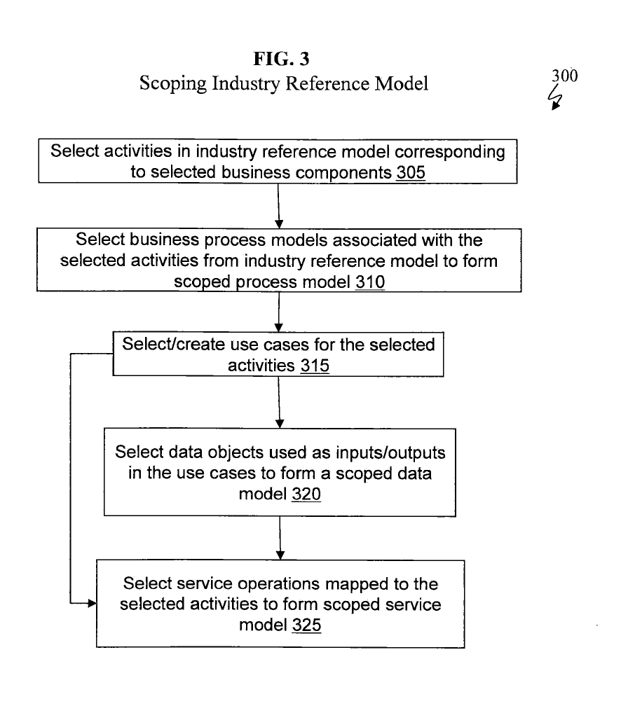

Since the industry reference model 110 may be very large, based on the selected business components 105a (via the selected activities) the software tool 20 is configured to locate and select corresponding business process models in the process model 110a, locate and select corresponding informal data objects in the business process models 110a, locate and select corresponding service operations in the service model 110c, and locate and select corresponding formal data objects in the data model 110b, to form the smaller scoped industry reference model 204. Scoping the industry reference model 110 to generate the scoped industry reference model 204 is further discussed with reference to FIG. 3. For simplicity, note that the scoped industry reference model 204 comprises the elements of and may be represented in FIG. 1 by the industry reference model 110 but the scoped industry reference model 204 is a scaled down version of the industry reference model 110 based on the selected business components 105a (via corresponding selected activities). Accordingly, reference to business process models 110a, data models 110b, and/or service models 110c applies to the scoped reference industry model 204.

At operation 215, the software tool 20 provides (displays) to the user the activities of the selected industry reference activities 202 (which correspond to the selected business components 105a from the business function decomposition model 105) for the user to modify, e.g., using the user interface 50 (a mouse), the activities in the selected industry reference activities 202 to reflect business requirements of the user's real business. For example, the software module 20 may reduce/scope the activities of the industry reference model 110 down to the number of activities (in selected industry reference activities 202) that correspond to the selected business components 105a for further customization by the user. Also, the software tool 20 can receive additions, deletions, and/or changes by the user to activities and to activity flows between activities in the selected industry reference activities 202. An activity flow (also referred to as a flow or data flow) is a connection between one activity and another activity. Via the software tool 202, the user can check each activity and customize each activity to the user's business scenario. Similarly, via the software tool 20, the user can customize the activity flows to capture information needs of the real business. Activities in the selected industry reference activities 202 are associated with business process models of the business process models 110a, and the user can modify the informal data objects of the business process models via the software tool 20. All changes, modifications, deletions, and additions to the selected industry reference activities 202 (are output) result in an analyzed activities (process) model 206 (stored in memory 15) that is customized to the user's scenario (requirements). For instance, in a process model, activity A (such as Establish Customer) is connected to activity B (such as Open Account) through a data flow. A user inserts another activity, say activity C (such as Allocate Funds), between A and B. This insertion changes the data flows as A is connected to C and then C is connected to B (but A is no longer directly connected to B).

At operation 220, the software tool 20 is configured to utilize the analyzed activities model 206 and the scoped industry reference model 204 along with inputs made by the user to output a process design model 208.

The user (via user interface 50) can add design details for each activity (such as, e.g. atomic/composite service operations of the service models 110c). The user can modify the data model 110b (for the service models 110c) to support information processing during process execution. Often, an industry reference model provides service model details for common activities and also a generic data model. For the activities of the analyzed process model 206, the software tool 20 is configured to extract relevant service operations in the service models 110c (of the scoped industry reference model 204) and formal data objects in the data models 110b (of the scoped industry reference model 204) to result in the process design model 208. The purpose of the process design model 208 is to link each activity with the appropriate service operation in the scoped reference model 204 and map the informal data objects into formal (normalized) data objects in the scoped reference model 204.

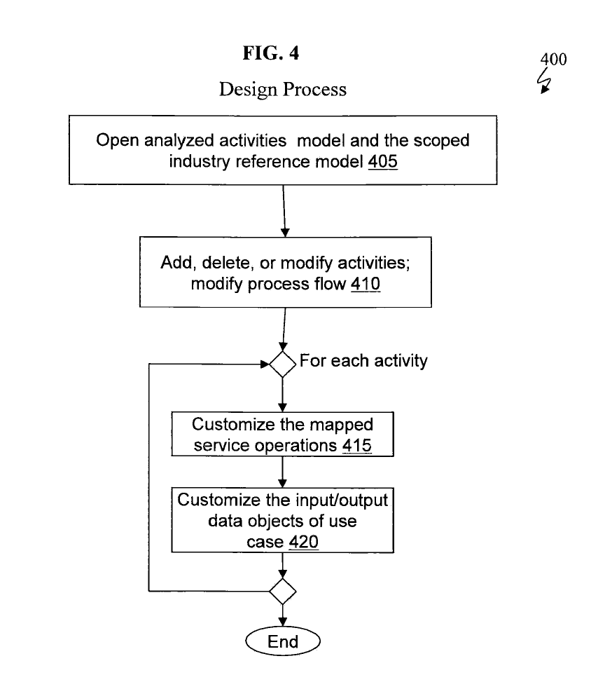

Additionally, the user can utilize the software tool 20 to determine if each of the selected activities in the analyzed activities model 206 can be automated or not. If the activity can be automated the software tool 20 (and/or the user) finds a corresponding service operation in the service model 110c to automate the activity. If the activity cannot be automated because the activity is not linked (mapped) to a corresponding service operation (in the service model 110c), the software tool 20 is configured to display on the display 45 a hint to the user. For example, when the software tool 20 discovers an activity 1 that has no mapped service operations in service models 110c, the software module 20 is configured to search for appropriate service operations by a collection of criteria, such as, e.g., description of service operations, input/output parameters, etc. Further, the software tool 20 is configured to generate a service operation (which can further be customized in later phases) to perform the identified activity. If the user accepts (by selecting “yes”) this suggestion (the user is displayed the option to select “yes” or “no” on the display 45), the software tool 20 is configured to map activity 1 to the suggested service operation, thus automating activity 1. The design process of operation 220 is further discussed with reference to FIG. 4.

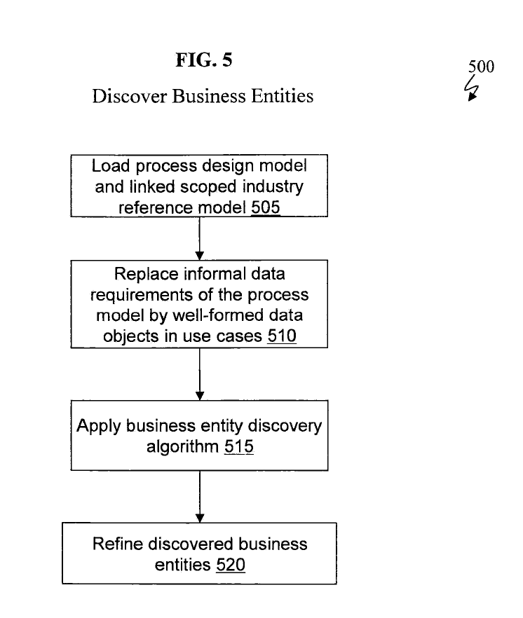

At operation 225, the software tool 20 is configured to discover business entities to output a business entity-centric solution model 214 based on the process design model 208, the scoped industry reference model 204, and a solution model profile 212. The solution model profile 212 is a template that instructs the software tool module 20 how business entities will be represented. Further details of operation 225 are now provided with reference to FIG. 5. FIG. 5 is a flow chart 500 illustrating discovering business entities to form the business entity-centric solution model 214 (of operation 225) in accordance with exemplary embodiments. The business entity-centric solution model 214 may comprise any number (“X”) of business entities. The software tool 20 loads the process design model 208 and the scoped industry reference model 204 at operation 505.

At operation 510, for the activities, the software tool 20 replaces the informal input/output data objects of the process design model 208 with formal input/output data objects of the mapped use cases. Each activity has a use case, which is an analysis of that activity; further, the use case is the specification and parameter definitions of that activity, and the use case is linked (mapped) to service operations in the service model 110c.

At operation 515, the software tool 20 applies its business entity discovery algorithm. The algorithm of the software tool 20 takes the process design model 208, the solution model profile 212 (which is a template for representing business entities), and the scoped industry reference model 204 as input to output the discovered business entities. Business entity-centric modeling provides an approach to modularizing the activities (or the business processes of the business process models 110a). A business entity is characterized by a self-contained information model and a streamlined lifecycle model. Activities (also referred to as business processes) are represented as interacting business entities. The algorithm of the software tool 20 is configured to discover business entities from the process design model 208 and replace the informal data objects with formal data objects. The software tool 20 creates the business entities in the business entity-centric solution model 214. A business entity is a dominant data object. A data object, say e1, dominates another object, say e2, if (1) for every activity that e2 is an input (output), e1 is also an input (output); and (2) e1 is an input or output of an activity where e2 is not. A dominant data entity is one that is not dominated by any other data object. The information model of the business entity is formed by the dominant data object and its dominated data objects. The lifecycle model of the business entity is formed from the activities for which the dominant data object is an output, and from the flows between the activities. (For reference, further information can be found in the following application which is herein incorporated by reference, entitled “Automatic Generation Of Executable Components From Business Process Models”, Ser. No. 11/945,297, filed on Nov. 27, 2007.)

At operation 520, the software tool 20 refines the discovered business entities of the business entity-centric solution model 214 based on knowledge in the scoped industry reference model 204. For example, the software tool 20 may navigate (i.e., parse) the data model 110b of the scoped industry reference model 204 to refine the discovered business entities based on rules 70 (which capture the industry knowledge as a set of well defined rules for identifying and refining business entities). For instance, if a discovered entity “Business Arrangement” is a super type or a dependent type of another “Arrangement” in the data model 110b, the super type “Business Arrangement” may not be a valid business entity, and the software tool 20 alerts the user on the display 45 and/or automatically removes the super type “Business Arrangement.” As another example with respect to an IFW Business Object Model, there are abstract and concrete data classes. A concrete data class extends from the abstract one. A concrete data class may be considered as a candidate business entity by the software tool 20 (e.g., displayed to the user).

Consequently, the software tool 20 is configured to extract the knowledge of the industry reference model 204 and represent the knowledge as rules 70. For example, if both an abstract class (e.g. Arrangement) and a concrete class (FinancialSerivceArrangement) which extends from the abstract one are identified as business entities by the algorithm of the software tool 20, the software tool 20 is configured to merge these two business entities (based on the rules 70). As such, the software tool 20 is configured to apply the rules 70 to refine discovered business (artifacts) entities. For example, based on the rule 70, the software module 20 merges “Arrangement” and “FinancialServiceArrangement” into a single business entity named “FinancialServiceArrangement”. The information model includes “Arrangement” class, and the business entity's lifecycle model includes activities acting on either “Arrangement” or “FinancialServiceArrangement”.

Additionally, regarding the rules 70, the user can previously specify predefined rules to store in the rule 70 via the software tool 20. Also, the user can identify a collection of formal data objects and/or further define formal data objects (of the data model 110b) with knowledge from the industry reference model 204.

The software tool 20 may represent business entities as service components. Each business entity (of the business entity-centric solution model 214) created by the software tool 20 has two primary components: information model (data model) and lifecycle model. The information model includes the dominant and dominated data classes (as identified by entity discovery algorithm of the software tool 20), and other classes associated with the dominant and dominated classes in the scoped reference model 204. A data service interface is created (by the software tool 20) for data operations (e.g. Create, Search, Update, Delete). The lifecycle model includes the activities acting on the dominant and dominated data classes. A lifecycle model is represented as a state machine by the software tool 20, and a state is created for each activity output with the business entity. A state transition is created by the software tool 20 for each activity and the state transition is associated with the service operations (of the service model 110c) mapped to this activity in the scoped reference model 204. By the software tool 20, a state machine service interface is provided to expose services of the service operations (e.g., from the scoped industry reference model 204) associated with state transitions. Each state corresponds to an activity output, and the state transition is associated with service operations; if the service operation is a composite service operation (i.e., has many steps) as determined by the software tool 20, the software tool 20 generates an activity flow for the composite service operation.

For reference, further information regarding discovering business entities can be found in “Automatic Generation Of Executable Components From Business Process Models”, Ser. No. 11/945,297, filed on Nov. 27, 2007.

At operation 230, via the software module 20, the user can validate business entities (displayed on the display 45 by the software tool 20) of the business entity-centric solution model 214 by utilizing the user interface 45, and the software tool 20 outputs (displays) a customized solution model 216 (or a customized business entity-centric solution model 216). The customized solution model 216 may be stored in the memory 15.

Via the software tool 20, the user can further customize business entity-centric solution model 214 by validating data class attributes and validating data class associations. For example, to validate each data class attribute and data class associations, the software tool 20 may display the validation options in which the user may select “yes” to accept and “no” reject.

Also, the user can customize the state machine design (i.e., service operations) to validate and/or modify services associated with the state transitions, and to validate composite service operations (from the service model 110c).

Via the software tool 20, the user may wire service components in which a service exposed at one service component may be used by other service components, and the user may add any necessary external services. Note that business entities may be referred to as service components. Additionally, one skilled in the art is familiar with service-oriented architecture (SOA) which is a flexible set of design principles used during the phases of systems development and integration. By “Service components”, the present disclosure means “components” in Service Component Architecture (SCA). In SCA, “a component consists of a configured instance of an implementation, where an implementation is the piece of program code providing business functions. The business function is offered for use by other components as services. Implementations may depend on services provided by other components and these dependencies are called references. Implementations can have settable properties, which are data values which influence the operation of the business function. The component configures the implementation by providing values for the properties and by wiring the references to services provided by other components.”

At operation 235, the software tool 20 is configured to generate runtime artifacts 217, and the runtime artifacts 217 are one or more software programs for the user/organization. Further, IBM® Rational® Software Architect (also known as Rational® Software Architect for WebSphere® Software) has a capability called “SOA transformation” which can generate runtime artifacts (such as the runtime artifacts 217) from the customized business solution produced via the software tool 20. For reference, information regarding generating runtime artifacts for the runtime environment can be found in the application entitled “Automatic Generation Of Executable Components From Business Process Models”, Ser. No. 11/945,297, filed on Nov. 27, 2007 incorporated herein by reference.

The software tool 20 is configured to execute several transformations to generate runtime artifacts 217. The workflow/Business Process Execution Language (BPEL) transformation is performed by the software tool 20 to transform composite services (i.e., composite service operations of the service model 110c) into BPEL. BPEL is short for Web Services Business Process Execution Language (WS-BPEL).

Business State Machine transformation is performed by the software tool 20 in which a state machine in a service component (business entity) is transformed into an executable business state machine in runtime. A state machine is a model of behavior composed of a finite number of states, transitions between those states, and actions.

Data transformation is performed by the software tool 20, where the information model is transformed into data objects and where a script for creating a physical data model is generated.

Web Services Definition (or Description) Language transformation is performed by the software tool 20 in which service interfaces are transformed into WSDL, and the WSDL generates web services interfaces.

Runtime artifacts are wired to become an executable solution. It is noted that one skilled in the art understands executing transformations to generate runtime artifacts. Although the runtime artifacts 217 may be executed during runtime on the computer 10, the runtime artifacts 217 may be provided to and executed on another computer and/or across multiple computers. “Wired” means linking the references of a component to the components which provide the referenced services.

FIG. 3 is a flow chart 300 further illustrating operations 205 and 210 for scoping the industry reference model 110 to form the scoped industry reference model 204 in accordance with exemplary embodiments. The scoped industry reference model 204 comprises scoped (i.e., reduced in number) business process models 110a, scoped data models 110b, and scoped service models 110c output as the scoped industry reference model 204.

At operation 305, the software tool 20 receives the selection of business components 105a from the business function decomposition model 105, and the software tool 20 recursively extracts all corresponding activities in the business process model 110a (including sub-processes) of the industry model 110. The activities corresponding to the selected business components 105a may be considered selected activities.

At operation 310, in response to the user selecting business components 105a in the business function decomposition model 105, the software tool 20 forms a scoped business process model 110a. The business components 105a are linked to activities in the industry reference model 110. Each activity is associated with a particular business process model in the business process models 110a; each business process model 110a may be associated with one or more than one selected activity. Based on the selected business components 105a which are linked to activities in the business process models 110a, the software tool 20 is configured to determine the corresponding business process models out of the numerous business process models 110a. Accordingly, the software tool 20 forms a scoped business process model from the business processes model 110a.

Each activity has a use case, and the use case is an analysis of that activity. The use case is the specification and parameter definitions of the activity. Also, the use case is a mapping to formal data objects in the data model 110b. The use case is linked to a service operation in the service models 110c of the industry reference model 110. One skilled in the art understands that a use case is a description of a system's behavior as it responds to a request that originates from outside of that system (activity). In other words, a use case describes “who” can do “what” with regard to the system in question.

At operation 315, the software tool 20 searches the use cases in the reference industry model 110 that match the selected activities based on the linkages between activities and use cases. The software tool 20 gathers a collection of use cases that correspond to the activities. The sub-processes of the business models 110a may contain activities too. If such linkages (mappings between the selected activities and use cases the business process model 110a) do not exist for a selected activity, a user manually searches for a matching use case within the use cases in the business model 110a, and/or the user creates a use case for any activity that is not linked to a use case via the software tool 20. Since the business process model 110a is now the scoped business process model 110a, the user does not have to search through an enormous number of business process models 110a to find a matching use case but can utilize the software tool 20 to search the scoped business process models 110a.

At operation 320, to form a scoped data model 110b, the software tool 20 collects (and displays) formal data objects (which are inputs and outputs (input/output)) in the selected use cases; the software tool 20 removes redundancies in the formal data objects because some use cases may be linked (mapped) to the same formal data objects in the data models 110b, and the software tool 20 maintains the data (object) relationships (mapping) among these formal data objects (which are inputs/outputs of the use cases). As an example of a data object relationship that is maintained, a formal data object of a use case may be a supertype to a formal data object of another use case, and this data relationship between the two formal data objects is maintained by the software tool 20, when scoping the data models 110b.

At operation 325, to form a scoped service model 110c, the software tool 20 searches (and finds) the service operations of the service models 110c in the industry reference model 110 that match the selected activities based on the linkages (mapping) between the selected activities and service operations. If such linkages do not exist, a user manually searches the industry reference model 110 to match service operations in service model 110c to selected activities via the software tool 20.

FIG. 4 is a flow chart 400 further illustrating operation 220 for the design process in accordance with exemplary embodiments.

At operation 405, the software tool 20 opens the analyzed activities (process) model 206 and the (linked) scoped industry reference model 204, which are stored in memory 15.

At operation 410, via the software tool 20, the user customizes activities and activity flows in the analyzed activities (process) model 206 to adapt them to the real business of the user. As mentioned herein, an activity flow is a link or connection between two activities. By interfacing with the software tool 20 via user interface 50, the user can add, delete, and/or modify activities of the analyzed activities model 206, and the user can modify the activity flows between activities.

As discussed herein, each activity has a use case, and the use case is mapped to service operations in the service models 110c. At operation 415, via the software tool 20, the user confirms that the service operations in the service models 110c mapped to the activities in the analyzed process model 206 are correct; additionally, the user may navigate through the linked scoped industry reference model 204 to map the activity to service operations in service model 110c manually via the software tool 20 for incorrect mappings between the activity and service operations and for activities not mapped to any service operations. For example, the software tool 20 is configured to display to the user on display 45 any activities not mapped to service operation; if there is an activity that is not mapped to service operations in the service models 110c, the user can manually map the activity to service operations in the service model 110c via the software tool 20. The service operations implement the particular activity.

At operation 420, the user customizes the input/output data objects of the mapped use case by adding and removing data objects (of the data object model 110b) to reflect actual business requirements/activities via the software tool 20. For example, the software tool 20 presents (displays to the user) the formal data objects that correspond to activities of the analyzed activities model 206, so that the user can customize these formal data objects. (Note that customization occurs on the scoped industry reference model 204 not the entire industry reference model 110 so there fewer formal data objects in the data model 110b for the user to view). Each use case is associated with formal input/output data objects, and the user can customize these formal data objects via the software tool 20. This process loops and continues until each activity of the analyzed activities model 206 has been customized (as desired)

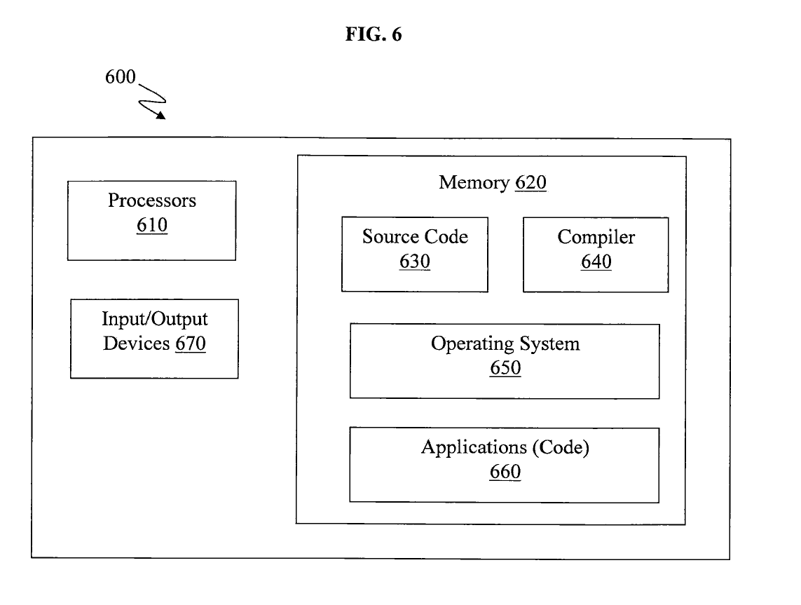

FIG. 6 illustrates an example of a computer 600 having capabilities, which may be included in exemplary embodiments. Various methods, procedures, modules, flow diagrams, tools, application, and techniques discussed herein may also incorporate and/or utilize the capabilities of the computer 600. Moreover, capabilities of the computer 600 may be utilized to implement features of exemplary embodiments discussed herein. One or more of the capabilities of the computer 600 may implement any element discussed herein such as but not limited to the computer 10.

Generally, in terms of hardware architecture, the computer 600 may include one or more processors 610, computer readable storage memory 620, and one or more input and/or output (I/O) devices 670 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 610 is a hardware device for executing software that can be stored in the memory 620. The processor 610 can be virtually any custom made or commercially available processor, a central processing unit (CPU), a data signal processor (DSP), or an auxiliary processor among several processors associated with the computer 600, and the processor 610 may be a semiconductor based microprocessor (in the form of a microchip) or a macroprocessor.

The computer readable memory 620 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 620 may incorporate electronic, magnetic, optical, and/or other types of storage media. Note that the memory 620 can have a distributed architecture, where various components are situated remote from one another, but can be accessed by the processor 610.

The software in the computer readable memory 620 may include one or more separate programs, each of which comprises an ordered listing of executable instructions for implementing logical functions. The software in the memory 620 includes a suitable operating system (O/S) 650, compiler 640, source code 630, and one or more applications 660 of the exemplary embodiments. As illustrated, the application 660 comprises numerous functional components for implementing the features, processes, methods, functions, and operations of the exemplary embodiments. The application 660 of the computer 600 may represent numerous applications, agents, software components, modules, interfaces, controllers, etc., as discussed herein but the application 660 is not meant to be a limitation.

The operating system 650 may control the execution of other computer programs, and provides scheduling, input-output control, file and data management, memory management, and communication control and related services.

The application(s) 660 may employ a service-oriented architecture, which may be a collection of services that communicate with each. Also, the service-oriented architecture allows two or more services to coordinate and/or perform activities (e.g., on behalf of one another). Each interaction between services can be self-contained and loosely coupled, so that each interaction is independent of any other interaction.

Further, the application 660 may be a source program, executable program (object code), script, or any other entity comprising a set of instructions to be performed. When a source program, then the program is usually translated via a compiler (such as the compiler 640), assembler, interpreter, or the like, which may or may not be included within the memory 620, so as to operate properly in connection with the O/S 650. Furthermore, the application 660 can be written as (a) an object oriented programming language, which has classes of data and methods, or (b) a procedure programming language, which has routines, subroutines, and/or functions.

The I/O devices 670 may include input devices (or peripherals) such as, for example but not limited to, a mouse, keyboard, scanner, microphone, camera, etc. Furthermore, the I/O devices 670 may also include output devices (or peripherals), for example but not limited to, a printer, display, etc. Finally, the I/O devices 670 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 670 also include components for communicating over various networks, such as the Internet or an intranet. The I/O devices 670 may be connected to and/or communicate with the processor 105 utilizing Bluetooth connections and cables (via, e.g., Universal Serial Bus (USB) ports, serial ports, parallel ports, FireWire, HDMI (High-Definition Multimedia Interface), etc.).

When the computer 600 is in operation, the processor 610 is configured to execute software stored within the memory 620, to communicate data to and from the memory 620, and to generally control operations of the computer 600 pursuant to the software. The application 660 and the O/S 650 are read, in whole or in part, by the processor 610, perhaps buffered within the processor 610, and then executed.

When the application 660 is implemented in software it should be noted that the application 660 can be stored on virtually any computer readable storage medium for use by or in connection with any computer related system or method. In the context of this document, a computer readable storage medium may be an electronic, magnetic, optical, or other physical device or means that can contain or store a computer program for use by or in connection with a computer related system or method.

The application 660 can be embodied in any computer-readable medium 620 for use by or in connection with an instruction execution system, apparatus, server, or device, such as a computer-based system, processor-containing system, or other system that can fetch the instructions from the instruction execution system, apparatus, or device and execute the instructions. In the context of this document, a “computer-readable storage medium” can be any means that can store, read, write, communicate, or transport the program for use by or in connection with the instruction execution system, apparatus, or device. The computer readable medium can be, for example but not limited to, an electronic, magnetic, optical, or semiconductor system, apparatus, or device.

More specific examples (a nonexhaustive list) of the computer-readable medium 620 would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 660 is implemented in hardware, the application 660 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It is understood that the computer 600 includes non-limiting examples of software and hardware components that may be included in various devices, servers, and systems discussed herein, and it is understood that additional software and hardware components may be included in the various devices and systems discussed in exemplary embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the exemplary embodiments of the invention have been described, it will be understood that those skilled in the art, both now and in the future, may make various improvements and enhancements which fall within the scope of the claims which follow. These claims should be construed to maintain the proper protection for the invention first described.

What is claimed is:

1. A computer implemented method of a computer for forming a business entity model from an industry reference model, comprising:
receiving data of a business function model, the business function model comprising business components;
receiving data of an industry reference model;
receiving a selection of business components in the business function model to be selected business components;
finding activities in the industry reference model to be selected activities that correspond to the selected business components;
based on the selected activities, reducing the industry reference model to be a scoped industry reference model, wherein reducing the industry reference model comprises:
reducing business process models in the industry reference model to selected business process models that correspond to selected activities;
reducing data models in the industry reference model to selected data models that correspond to use cases of the selected activities; and
reducing service operations in the industry reference model to selected service operations that correspond to the selected activities;
receiving input for customizing the selected activities and the scoped industry reference model;
based on a business entity template, the selected activities, and the scoped industry reference model, generating business entities to form a business entity model as a software program.

2. The computer implemented method of claim 1, further comprising generating runtime artifacts from the business entity model to be executed during runtime as the software program.

3. The computer implemented method of claim 1, wherein receiving input for customizing the selected activities and the scoped industry reference comprises receiving input from a user for at least one of:
modifying activities of the selected activities to reflect business requirements;
modifying connections between activities of the selected activities;
confirming that service operations of the scoped industry reference model map to the selected activities; and
confirming that data objects for uses cases of the selected activities reflect the business requirements.

4. The computer implemented method of claim 1, further comprising transforming the business entities of the business entity model into service components of Service Oriented Architecture (SOA).

5. The computer implemented method of claim 1, further comprising displaying to a user the selected business models for the user to customize.

6. The computer implemented method of claim 1, further comprising displaying to the user the selected data models for the user to customize.

7. The computer implemented method of claim 1, further comprising displaying to the user selected service operations for the user to customize.

8. A computer program product for forming a business entity model from an industry reference model, the computer program product comprising:
a computer readable storage medium having computer readable program code embodied therewith, the computer readable program code for forming the business entity model comprising:
receiving a business function model, the business function model comprising business components;
receiving an industry reference model;
receiving a selection of business components in the business function model to be selected business components;
finding activities in the industry reference model to be selected activities that correspond to the selected business components;
based on the selected activities, reducing the industry reference model to be a scoped industry reference model, wherein reducing the industry reference model comprises:
reducing business process models in the industry reference model to selected business process models that correspond to selected activities;
reducing data models in the industry reference model to selected data models that correspond to use cases of the selected activities; and
reducing service operations in the industry reference model to selected service operations that correspond to the selected activities;
receiving input for customizing the selected activities and the scoped industry reference model;
based on a business entity template, the selected activities, and the scoped industry reference model, generating business entities to form a business entity model as a software program.

9. The computer program product of claim 8, further comprising generating runtime artifacts from the business entity model to be executed during runtime as the software program.

10. The computer program product of claim 8, wherein customizing the selected activities and the scoped industry reference comprises receiving input from a user for at least one of:
modifying activities of the selected activities to reflect business requirements;
modifying connections between activities of the selected activities;
confirming that service operations of the scoped industry reference model map to the selected activities; and
confirming that data objects for uses cases of the selected activities reflect the business requirements.

11. The computer program product of claim 8, further comprising transforming the business entities of the business entity model into service components of Service Oriented Architecture (SOA).

12. The computer program product of claim 8, further comprising displaying to a user the selected business models for the user to customize.

13. The computer program product of claim 8, further comprising displaying to the user the selected data models for the user to customize.

14. The computer program product of claim 8, further comprising displaying to the user selected service operations for the user to customize.

15. A computer implemented method of a computer for forming a business entity model from an industry reference model, comprising:
receiving a business function model, the business function model comprising business components;
receiving an industry reference model;
receiving a selection of business components in the business function model to be selected business components;
finding activities in the industry reference model to be selected activities that correspond to the selected business components;
based on the selected activities, scoping the industry reference model to be a scoped industry reference model, wherein scoping the industry reference model comprises:
reducing business process models in the industry reference model to selected business process models that correspond to selected activities;
reducing data models in the industry reference model to selected data models that correspond to use cases of the selected activities; and
reducing service operations in the industry reference model to selected service operations that correspond to the selected activities;
based on a business entity template, the selected activities, and the scoped industry reference model, generating business entities to form a business entity model as a software program.

16. The method of claim 15, further comprising generating runtime artifacts from the business entity model to be executed during runtime as the software program.

17. The method of claim 15, further comprising receiving input for customizing the selected activities and the scoped industry reference model, which comprises receiving input from a user for at least one of:
modifying activities of the selected activities to reflect business requirements;
modifying connections between activities of the selected activities;
confirming that service operations of the scoped industry reference model map to the selected activities; and
confirming that data objects for uses cases of the selected activities reflect the business requirements.

18. The method of claim 15, further comprising transforming the business entities of the business entity model into service components of Service Oriented Architecture (SOA).

19. The method of claim 15, further comprising displaying to a user the selected business models for the user to customize.

20. The method of claim 15, further comprising displaying to the user the selected data models for the user to customize.

21. The method of claim 15, further comprising displaying to the user selected service operations for the user to customize.
